(19) United States
(12) Patent Application Publication
(10) Pub. No.: US 2017/0237095 A1
(43) Pub. Date: Aug. 17, 2017

(54) FUEL CELL DEVICE AND OPERATION CONTROL METHOD FOR FUEL CELL DEVICE

(71) Applicant: FUJI ELECTRIC CO., LTD., Kawasaki (JP)

(72) Inventors: Hisanobu YOKOYAMA, Tokyo (JP); Yuji SUZUKI, Tokyo (JP); Nobuaki OHGURI, Tokyo (JP)

(73) Assignee: FUJI ELECTRIC CO., LTD., Kawasaki (JP)

(21) Appl. No.: 15/416,598

(22) Filed: Jan. 26, 2017

(30) Foreign Application Priority Data
Feb. 12, 2016 (JP) 2016-024902
Aug. 9, 2016 (JP) 2016-156584

(51) Int. Cl. H01M 8/04955; H01M 8/04746; H01M 8/04701; H01M 8/0444; H01M 8/0432

(52) U.S. Cl. CPC H01M 8/04955; H01M 8/0444; H01M 8/0432; H01M 8/04701; H01M 8/04753; H01M 2008/1293

(57) ABSTRACT

A fuel cell device includes a solid oxide fuel cell; an air-tight housing accommodating the solid oxide fuel cell; a gas concentration detector detecting a gas concentration of a combustible stagnant gas; and a controller performing an emergency stop by instantly stopping the supply of the fuel to the fuel electrode when the gas concentration is higher than an upper limit concentration and performing a normal stop by lowering a temperature of the fuel cell device while supplying the fuel to the fuel electrode when the gas concentration is not higher than the upper limit concentration and the gas concentration is higher than a predetermined concentration.

### CROSS-REFERENCE TO RELATED APPLICATION(S)

The present application claims priority to and incorporates by reference the entire contents of Japanese Patent Application No. 2016-024902 filed in Japan on Feb. 12, 2016 and Japanese Patent Application No. 2016-156584 filed in Japan on Aug. 9, 2016.

### BACKGROUND

The present disclosure relates to a fuel cell device and an operation control method for the fuel cell device.

In fuel cells, fuel gas cross-leaks to the air electrode side in some cases. A fuel cell module has difficulty in eliminating cross leak of the fuel gas. To address the difficulty, a differential pressure between a pressure in a fuel electrode and a pressure in an air electrode is decreased with high accuracy in order to reduce a cross leak amount of the fuel gas to be within a defined value, a load fluctuation speed is decreased in order to prevent increase in the cross leak amount of the fuel gas due to heat shock or the like, and so on.

The cross leak amount of the fuel gas is indirectly detected by detecting local heat generation, deterioration in characteristics, and the like in the fuel cell because it is difficult to directly measure the cross leak amount during operation. As a result, an abnormal state of the fuel cell in which the cross leak amount of the fuel gas is equal to or higher than the defined value incapable of being detected rapidly and damage on the fuel cell is increased due to combustion of the fuel gas at the outside of the air electrode, or the like.

Japanese Laid-open Patent Publication No. 2003-229148 discloses that a gas detection sensor is installed in an upper portion of a package accommodating therein a fuel cell and the like to detect a gas concentration of combustible stagnant gas that leaks in the package, and gas concentration adjustment involving discharge of the combustible stagnant gas with a ventilation fan is performed when the gas concentration is equal to or higher than a defined value.

Japanese Laid-open Patent Publication No. 2006-294497 discloses that terms and conditions related to cross leak are set and emergency stop of stopping supply of hydrogen to anodes and stopping operation of a fuel cell stack is carried out when the terms and conditions are not satisfied.

### SUMMARY

According to an embodiment of the present disclosure, a fuel cell device includes a solid oxide fuel cell including a fuel electrode to which a fuel is supplied, an air electrode to which air is supplied, and an electrolyte provided between the fuel electrode and the air electrode; an air-tight housing in which the solid oxide fuel cell is arranged; a gas concentration detector detecting a gas concentration of a combustible stagnant gas stagnating in an upper portion of the air-tight housing; a differential pressure detector detecting a differential pressure between the fuel in the fuel electrode and the air in the air electrode; and a controller performing an emergency stop on the fuel cell device to stop the fuel cell device by instantly stopping the supply of the fuel to the fuel electrode when the gas concentration is higher than an upper limit concentration, performing an adjustment on the differential pressure such that the differential pressure is equal to or lower than a predetermined differential pressure when the gas concentration is not higher than the upper limit concentration, the gas concentration is higher than a predetermined concentration, and the differential pressure is higher than the predetermined differential pressure, and performing a normal stop on the fuel cell device to stop the fuel cell device by lowering a temperature of the fuel cell device while supplying the fuel to the fuel electrode when the differential pressure does not become equal to or lower than the predetermined differential pressure even by adjusting the differential pressure. Further, the adjustment of the differential pressure is performed by adjusting at least one of a flow rate of the fuel, a flow rate of the air, and an opening of a differential pressure regulating valve.

According to an embodiment of the present disclosure, a fuel cell device includes: a solid oxide fuel cell including a fuel electrode to which a fuel is supplied, an air electrode to which air is supplied, and an electrolyte provided between the fuel electrode and the air electrode; an air-tight housing in which the solid oxide fuel cell is arranged; a gas concentration detector detecting a gas concentration of a combustible stagnant gas stagnating in an upper portion of the air-tight housing; a temperature detector detecting a temperature of the solid oxide fuel cell; a differential pressure detector detecting a differential pressure between the fuel in the fuel electrode and the air in the air electrode; and a controller performing an emergency stop on the fuel cell device to stop the fuel cell device by instantly stopping the supply of the fuel to the fuel electrode when the gas concentration is higher than an upper limit concentration, performing an adjustment on the differential pressure such that the differential pressure is equal to or lower than a predetermined differential pressure when the gas concentration is not higher than the upper limit concentration, the gas concentration is higher than a predetermined concentration, and the differential pressure is higher than the predetermined differential pressure, performing an adjustment on the temperature such that the temperature is equal to or lower than a predetermined temperature when the gas concentration is higher than the predetermined concentration, the differential pressure is equal to or lower than the predetermined differential pressure, and the temperature is higher than the predetermined temperature, and performing a normal stop on the fuel cell device to stop the fuel cell device by lowering a temperature of the fuel cell device while supplying the fuel to the fuel electrode when the temperature does not become equal to or lower than the predetermined temperature even by adjusting the temperature. Further, the adjustment of the differential pressure is performed by adjusting at least one of a flow rate of the fuel, a flow rate of the air, and an opening of a differential pressure regulating valve, and the adjustment of the temperature is performed by adjusting at least one of the flow rate of the fuel and the flow rate of the air.

According to an embodiment of the present disclosure, a fuel cell device includes: a solid oxide fuel cell including a fuel electrode to which fuel is supplied, an air electrode to which air is supplied, and an electrolyte provided between the fuel electrode and the air electrode; an air-tight housing in which the solid oxide fuel cell is arranged; a gas concentration detector detecting a gas concentration of a combustible stagnant gas stagnating in an upper portion of the air-tight housing; a temperature detector detecting a temperature of the solid oxide fuel cell; and a controller performing an emergency stop on the fuel cell device to stop the fuel cell device by instantly stopping the supply of the fuel to the fuel electrode when the gas concentration is higher than an upper limit concentration, performing an adjustment on the temperature such that the temperature is equal to or lower than a predetermined temperature when the gas concentration is not higher than the upper limit concentration, the gas concentration is higher than a predetermined concentration, and the temperature is higher than the predetermined temperature, and performing a normal stop on the fuel cell device to stop the fuel cell device by lowering a temperature of the fuel cell device while supplying the fuel to the fuel electrode when the temperature does not become equal to or lower than the predetermined temperature even by adjusting the temperature. Further, the adjustment of the temperature is performed by adjusting at least one of a flow rate of the fuel and a flow rate of the air.

According to an embodiment of the present disclosure, an operation control method is disclosed for a fuel cell device that includes a solid oxide fuel cell including a fuel electrode to which a fuel is supplied, an air electrode to which air is supplied, and an electrolyte provided between the fuel electrode and the air electrode, the solid oxide fuel cell being arranged in an air-tight housing. The operation control method includes detecting a gas concentration of a combustible stagnant gas stagnating in an upper portion of the air-tight housing and performing an emergency stop on the fuel cell device to stop the fuel cell device by instantly stopping the supply of the fuel to the fuel electrode when the gas concentration is higher than an upper limit concentration; detecting a differential pressure between the fuel in the fuel electrode and the air in the air electrode when the gas concentration is not higher than the upper limit concentration and the gas concentration is higher than a predetermined concentration, and performing an adjustment on the differential pressure such that the differential pressure is equal to or lower than a predetermined differential pressure when the differential pressure is higher than the predetermined differential pressure; and performing a normal stop on the fuel cell device to stop the fuel cell device by lowering a temperature of the fuel cell device while supplying the fuel to the fuel electrode when the differential pressure does not become equal to or lower than the predetermined differential pressure even by adjusting the differential pressure. Further, the adjustment of the differential pressure is performed by adjusting at least one of a flow rate of the fuel, a flow rate of the air, and an opening of a differential pressure regulating valve.

According to an embodiment of the present disclosure, an operation control method is disclosed for a fuel cell device that includes a solid oxide fuel cell including a fuel electrode to which fuel is supplied, an air electrode to which air is supplied, and an electrolyte provided between the fuel electrode and the air electrode, the solid oxide fuel cell being arranged in an air-tight housing. The operation control method includes detecting a gas concentration of a combustible stagnant gas stagnating in an upper portion of the air-tight housing and performing an emergency stop on the fuel cell device to stop the fuel cell device by instantly stopping the supply of the fuel to the fuel electrode when the gas concentration is higher than an upper limit concentration; detecting a differential pressure between the fuel in the fuel electrode and the air in the air electrode when the gas concentration is not higher than the upper limit concentration and the gas concentration is higher than a predetermined concentration, and performing an adjustment on the differential pressure such that the differential pressure is equal to or lower than a predetermined differential pressure when the differential pressure is higher than the predetermined differential pressure; detecting a temperature of the solid oxide fuel cell when the gas concentration is higher than the predetermined concentration and the differential pressure is equal to or lower than the predetermined differential pressure, and performing an adjustment on the temperature such that the temperature is equal to or lower than a predetermined temperature when the temperature is higher than the predetermined temperature; and performing a normal stop on the fuel cell device to stop the fuel cell device by lowering a temperature of the fuel cell device while supplying the fuel to the fuel electrode when the temperature does not become equal to or lower than the predetermined temperature even by adjusting the temperature. Further, the adjustment of the differential pressure is performed by adjusting at least one of a flow rate of the fuel, a flow rate of the air, and an opening of a differential pressure regulating valve, and the adjustment of the temperature is performed by adjusting at least one of the flow rate of the fuel and the flow rate of the air.

According to an embodiment of the present disclosure, an operation control method is disclosed for a fuel cell device that includes a solid oxide fuel cell including a fuel electrode to which fuel is supplied, an air electrode to which air is supplied, and an electrolyte provided between the fuel electrode and the air electrode, the solid oxide fuel cell being arranged in an air-tight housing. The operation control method includes detecting a gas concentration of combustible stagnant gas stagnating in an upper portion of the air-tight housing and performing an emergency stop on the fuel cell device to stop the fuel cell device by instantly stopping the supply of the fuel to the fuel electrode when the gas concentration is higher than an upper limit concentration; detecting a temperature of the solid oxide fuel cell when the gas concentration is not higher than the upper limit concentration and the gas concentration is higher than a predetermined concentration, and performing an adjustment on the temperature such that the temperature is equal to or lower than a predetermined temperature when the temperature is higher than the predetermined temperature; and performing a normal stop on the fuel cell device to stop the fuel cell device by lowering a temperature of the fuel cell device while supplying the fuel to the fuel electrode when the temperature does not become equal to or lower than the predetermined temperature even by adjusting the temperature. Further, the adjustment of the temperature is performed by adjusting at least one of a flow rate of the fuel and a flow rate of the air.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a block diagram illustrating an overall configuration of a fuel cell device according to an embodiment of the present disclosure;

FIG. 2 is a partially broken view illustrating a detail configuration of a fuel connection portion;

FIG. 3 is a view illustrating one example of a cooling unit of the fuel cell device of FIG. 1;

FIG. 4 is a view illustrating another example of the cooling unit of the fuel cell device of FIG. 1;

FIG. 5 is a flowchart illustrating an operation control processing procedure in response to a gas concentration by a controller;

FIG. 6 is a flowchart illustrating a first modification of the operation control processing procedure in response to the gas concentration performed by the controller;

FIG. 7 is a flowchart illustrating a second modification of the operation control processing procedures on the gas concentration performed by the controller; and

FIG. 8 is a flowchart illustrating a third modification of the operation control processing procedures in response to the gas concentration performed by the controller.

### DETAILED DESCRIPTION

As descried in Japanese Laid-open Patent Publication No. 2006-294497, when the combustible stagnant gas is discharged to the outside using the ventilation fan, a temperature in a housing of the fuel cell is unbalanced and the device is more likely to be in an emergency stop. The increase in the number of times of the emergency stop will reduce the lifetime of electrodes of the fuel cell. In particular, an operation temperature of a high-temperature type fuel cell such as a solid oxide fuel cell is in a range from approximately 600° C. to 1000° C. Accordingly, the emergency stop of the high-temperature type fuel cell will cause a temperature distribution in the cell due to the drastic temperature drop causing, for example a crack, resulting in a lifetime decrease of the fuel cell.

In the same manner, when the emergency stop is carried out whenever the terms and conditions are not satisfied as disclosed in Japanese Laid-open Patent Publication No. 2006-294497, that is, when the number of times of the emergency stop is increased, the lifetime of the fuel cell is accordingly decreased.

There is a need for a fuel cell device and an operation control method for the fuel cell device that can increase lifetime of a fuel cell module included in the fuel cell device by reducing the number of times of emergency stop even when the fuel cell module possibly causes therein cross leak of fuel gas to the air electrode side.

Hereinafter, modes for carrying out the present disclosure will be described with reference to the accompanying drawings.

### Overall Configuration

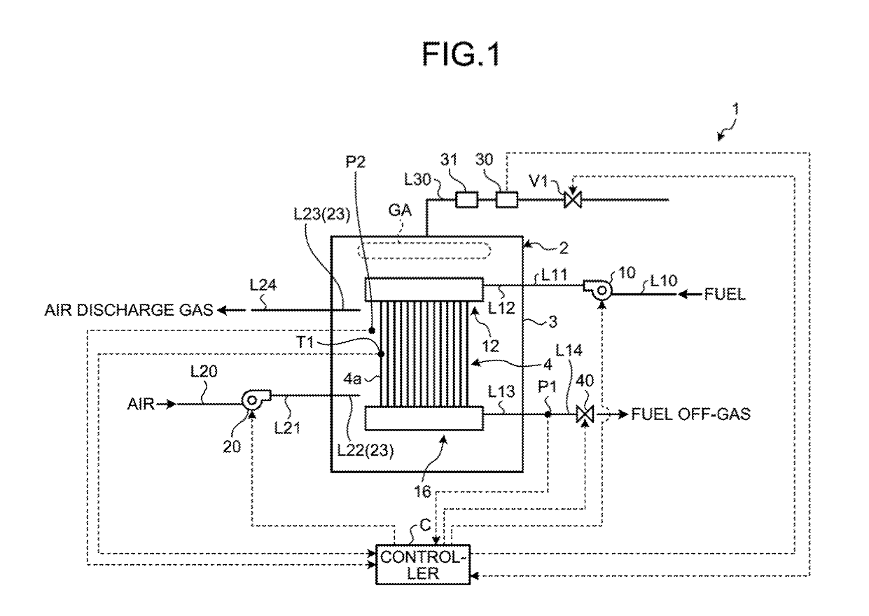

FIG. 1 is a block diagram illustrating an overall configuration of a fuel cell device 1 according to an embodiment of the present disclosure. The fuel cell device 1 includes a fuel cell module 2. The fuel cell module 2 has a fuel cell stack 4 provided in a heat insulation air-tight housing 3. The fuel cell stack 4 includes a plurality of power generation cells 4a. The power generation cells 4a generate an electric power by causing a fuel introduced from a fuel supply line L10 and air introduced from an air supply line L20 to react with each other.

The fuel cell stack 4 may have a well-known configuration such as a configuration in which the power generation cells 4a having a cylindrical shape are bundled with each other or a configuration in which the power generation cells 4a having a rectangular flat plate shape are stacked over each other. In the fuel cell stack 4 in this embodiment, the power generation cells 4a have the cylindrical shape, and fuel electrodes are formed at the inner side of the cylinders and air electrodes are formed at the outer side of the cylinders. Accordingly, fuel flows into the cylinders. The fuel cell stack 4 is a solid oxide fuel cell (SOFC) in which ion conductive ceramics as electrolyte is interposed between the fuel electrodes and the air electrodes.

The fuel supplied from the fuel supply line L10 is a hydrogen-rich fuel formed by removing a sulfur component from a raw fuel (for example, methane gas and town gas) (not illustrated) by using a desulfurizer (not illustrated) and reforming it by using a reformer (not illustrated).

A fuel supply blower 10 adjusts the flow rate of the fuel supplied from the fuel supply line L10. The fuel that is led out from the fuel supply blower 10 is supplied to a fuel connection portion 12 in the fuel cell module 2 through a fuel supply line L11 and a fuel supply line L12. The fuel flows into the fuel connection portion 12 from the fuel supply line L12. The fuel connection portion 12 supplies the fuel supplied from the fuel supply line L12 to the cylinders of the respective power generation cells 4a.

Fuel off-gas that has been reacted or has not been reacted in the power generation cells 4a of the fuel cell stack 4 is collected in a fuel connection portion 16 to be discharged through a fuel off-gas line L13 and a fuel off-gas line L14. The fuel off-gas line L14 includes a differential pressure regulating valve 40. The differential pressure regulating valve 40 is capable of regulating the flow rate. The pressure of the fuel gas in the fuel electrodes is increased when the differential pressure regulating valve 40 is narrowed whereas the pressure of the fuel gas in the fuel electrodes is decreased when it is open.

An air supply blower 20 adjusts the flow rate of the air supplied from the air supply line L20. The air that is led out from the air supply blower 20 is supplied into the fuel cell module 2 through an air supply line L21 and an air supply line L22 in the fuel cell module 2. The air led out from the air supply line L22 reacts with the fuel in the fuel electrodes through the air electrodes of the power generation cells 4a. The air in the fuel cell module 2 is discharged through an air discharge line L23 in the fuel cell module 2 and an air discharge line L24. The air supply line L22 and the air discharge line L23 configure an air connection portion 23.

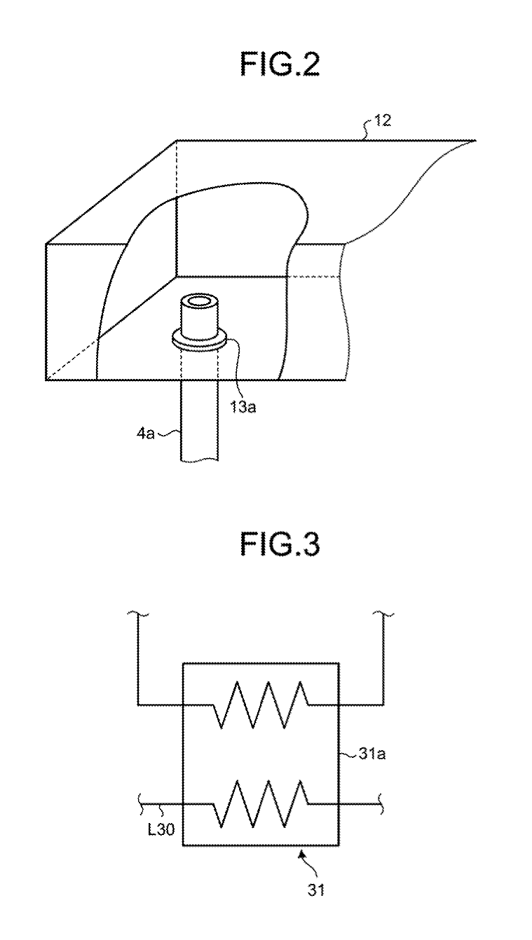

FIG. 2 is a partially broken view illustrating a detail configuration of the fuel connection portion 12. As illustrated in FIG. 2, the fuel connection portion 12 connects the cylindrical power generation cells 4a through seals 13a. The fuel pressure is higher than the air pressure and the temperature of the fuel cell stack 4 is changed from a normal temperature to a temperature in a range from approximately 600° C. to 1000° C. at the time of the activation. There is therefore a possibility that the fuel leaks from the seals 13a. In particular, the power generation cells 4a expand and contract in the axial direction and in the radial direction in accordance with the temperature change, which causes a fuel leakage with high probability. The leaked gas has hydrogen and methane as its main components and is lighter than air, and therefore stagnates in an upper portion of the heat insulation air-tight housing 3 as combustible stagnant gas GA.

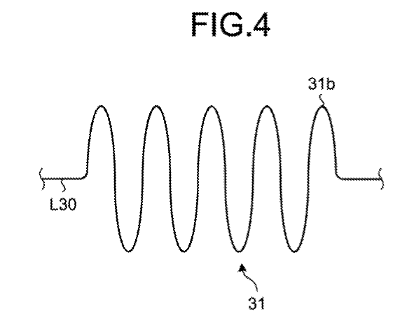

As illustrated in FIG. 1, a gas detection line L30 is connected to the upper portion of the heat insulation air-tight housing 3 and a gas concentration detector 30 detecting a gas concentration G of the combustible stagnant gas GA is provided on the gas detection line L30. A cooling unit 31 is provided at the upstream side relative to the gas concentration detector 30 on the gas detection line L30. The cooling unit 31 cools gas flowing through the gas detection line L30. The cooling unit 31 condenses water vapor flowing through the gas detection line L30. The cooling unit 31 may be provided with a heat exchanger 31a, as illustrated in FIG. 3, or may have a configuration in which the gas detection line L30 is formed by a meandering pipe 31b, as illustrated in FIG. 4. A valve V1 is provided on the downstream side of the gas concentration detector 30 and is open when the gas concentration detector 30 detects the gas concentration. It should be noted that a suction pump may be provided on the gas detection line L30 to suck the combustible stagnant gas GA at the time of detection of the gas concentration. The gas concentration detector 30 is provided outside of the fuel cell module 2 and can therefore detect the gas concentration even when a high-temperature type fuel cell, the operation temperature of which is in a range from approximately 600° C. to 1000° C., is employed.

As illustrated in FIG. 1, the fuel cell module 2 includes a pressure detector P1 detecting a fuel pressure at the outlet of the fuel electrode, a pressure detector P2 detecting an air pressure at the air electrode side, and a temperature detector T1 detecting a stack temperature T of the fuel cell stack 4. It should be noted that a differential pressure detector configured to detect a differential pressure between the fuel pressure and the air pressure may be provided instead of providing the pressure detectors P1 and P2. A controller C controls to perform a sampling detection of the gas concentration G of the combustible stagnant gas GA. The controller C controls to open the valve V1 in the detection of the gas concentration G of the combustible stagnant gas GA and acquires the gas concentration G detected by the gas concentration detector 30. Furthermore, the controller C acquires the fuel pressure detected by the pressure detector P1 and the air pressure detected by the pressure detector P2 to calculate a differential pressure ΔP between the fuel pressure and the air pressure. The controller C further acquires the stack temperature T detected by the temperature detector T1.

When the gas concentration G of the combustible stagnant gas GA that has been detected by the sampling detection is higher than an upper limit concentration Hth, the controller C controls to perform the emergency-stop on the fuel cell device 1. Herein the emergency stop causes the fuel cell device 1 to be stopped by blocking load of the fuel cell device 1 instantly, stopping supply of the fuel, stopping a heat source, and injecting only nitrogen as an inert gas into the fuel electrodes to lower the temperature of the fuel cell stack 4. It should be noted that air is continuously supplied to the air electrodes for cooling from the air electrode side. When the gas concentration G is higher than a predetermined concentration Gth (<upper limit concentration Hth) and the differential pressure ΔP is higher than a predetermined differential pressure ΔPth, the controller C adjusts the differential pressure by adjusting the flow rate(s) of the fuel supply blower 10 and/or the air supply blower 20 and/or adjusts the differential pressure by adjusting the opening of the differential pressure regulating valve 40 such that the differential pressure ΔP is equal to or lower than the predetermined differential pressure ΔPth. The predetermined concentration Gth is, for example, one third to one fourth of an explosion limit concentration and the upper limit concentration Hth is, for example, a half of the explosion limit concentration. When the gas concentration G is higher than the predetermined concentration Gth (<upper limit concentration Hth) and the stack temperature T is higher than a predetermined temperature Tth, the controller C adjusts the flow rate(s) of the fuel supply blower 10 and/or the air supply blower 20 such that the stack temperature T is equal to or lower than the predetermined temperature Tth. In this case, it is preferable that the flow rate of the air supply blower 20 be increased. The differential pressure is adjusted before the adjustment of the temperature because the differential pressure is controlled in order to decrease the gas leak amount between the fuel electrodes and the air electrodes as a direct cause of the increase in the gas concentration, and then, the temperature is controlled to maintain the operation of the fuel cell as long as possible.

When the differential pressure ΔP does not become equal to or lower than the predetermined differential pressure ΔPth even by adjusting the flow rate(s) of the fuel supply blower 10 and/or the air supply blower 20 or adjusting the opening of the differential pressure regulating valve 40 such that the differential pressure ΔP is equal to or lower than the predetermined differential pressure ΔPth in the case in which the gas concentration G has been higher than the predetermined concentration Gth (<upper limit concentration Hth) and the differential pressure ΔP has been higher than the predetermined differential pressure ΔPth, the controller C carries out a normal stop of stopping the fuel cell device 1 more moderately than the emergency stop. With the normal stop, the stack temperature T of the fuel cell stack 4 is lowered moderately. The normal stop is described below. The normal stop first lowers the temperature of the fuel cell stack 4 while injecting mixed gas of hydrogen as the fuel gas and nitrogen as the inert gas into the fuel electrodes. When the temperature of the fuel cell stack 4 has been lowered to approximately 400° C., the temperature of the fuel cell stack 4 is then lowered while injecting only nitrogen into the fuel electrodes. When the temperature of the fuel cell has been further lowered to approximately 100° C., the temperature of the fuel cell stack 4 may be lowered while injecting the air instead of nitrogen. It should be noted that air is continuously supplied to the air electrodes for cooling from the air electrode side. Furthermore, an operation load is stepwisely lowered from 100% while lowering the temperature of the fuel cell stack 4, and the flow rate of the gas that is supplied to the fuel electrodes is adjusted along therewith. Thus, the fuel cell device 1 is moderately stopped so as not to deteriorate the electrodes as less as possible. When the stack temperature T does not become equal to or lower than the predetermined temperature Tth even by adjusting the flow rate(s) of the fuel supply blower 10 and/or the air supply blower 20 such that the stack temperature T is equal to or lower than the predetermined temperature Tth in the case in which the gas concentration G has been higher than the predetermined concentration Gth (<upper limit concentration Hth) and the stack temperature T has been higher than the predetermined temperature Tth, the controller C carries out the normal stop of stopping the fuel cell device 1 more moderately than in the emergency stop.

### Operation Control Processing on Gas Concentration G

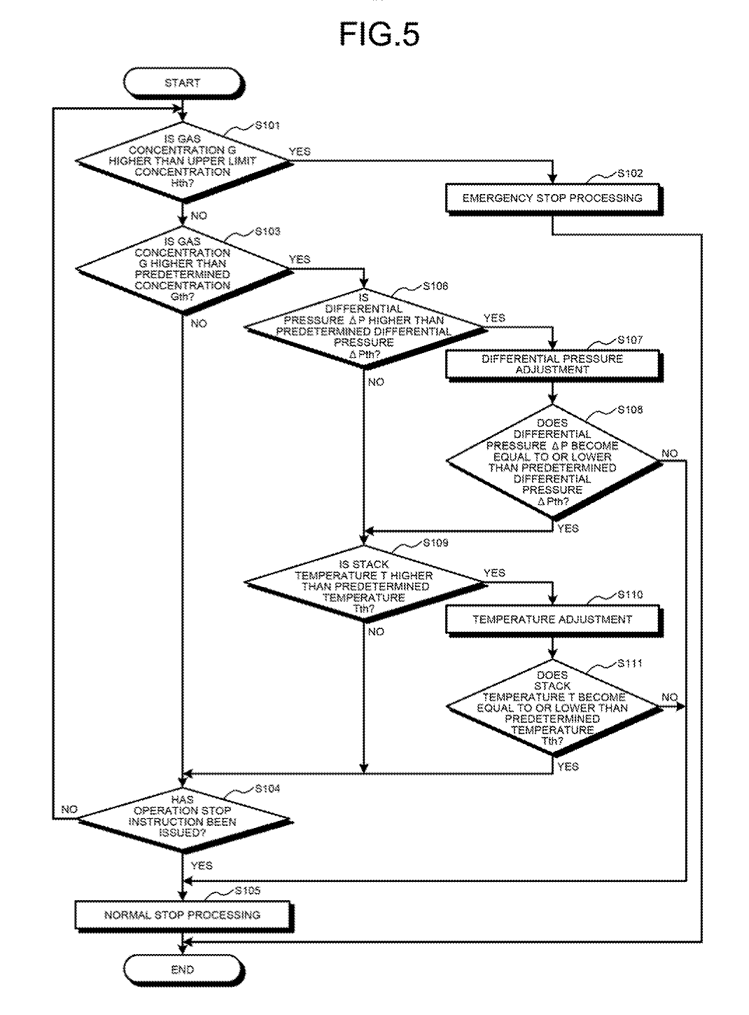

Next, the details of an operation control processing procedure on the gas concentration G by the controller C will be described with reference to a flowchart of FIG. 5. As illustrated in FIG. 5, first, the controller C determines whether the acquired gas concentration G is higher than the upper limit concentration Hth (step S101). If the gas concentration G is higher than the upper limit concentration Hth (Yes in step S101), the controller C controls to perform the emergency-stop on the fuel cell device 1 (step S102) and finishes the processing.

On the other hand, if the gas concentration G is not higher than the upper limit concentration Hth (No in step S101), the controller C further determines whether the gas concentration G is higher than the predetermined concentration Gth (<upper limit concentration Hth) (step S103). If the gas concentration G is not higher than the predetermined concentration Gth (No in step S103), the controller C further determines whether an operation stop instruction has been issued (step S104). If the operation stop instruction has been issued (Yes in step S104), the controller C controls to stop the operation normally (step S105) and finishes the processing. On the other hand, if the operation stop instruction has not been issued (No in step S104), the controller C shifts the process to step S101 and repeats the above-mentioned processing.

If the gas concentration G is higher than the predetermined concentration Gth (Yes in step S103), the controller C further determines whether the differential pressure ΔP is higher than the predetermined differential pressure ΔPth (step S106). If the differential pressure ΔP is higher than the predetermined differential pressure ΔPth (Yes in step S106), the controller C adjusts the differential pressure by adjusting the flow rate(s) of the fuel supply blower 10 and/or the air supply blower 20 and/or adjusts the differential pressure with the differential pressure regulating valve 40 such that the differential pressure ΔP is equal to or lower than the predetermined differential pressure ΔPth (step S107). Thereafter, the controller C determines whether the differential pressure ΔP becomes equal to or lower than the predetermined differential pressure ΔPth (step S108). If the differential pressure ΔP does not become equal to or lower than the predetermined differential pressure ΔPth (No in step S108), the controller C shifts the process to step S105, carries out the normal stop, and finishes the processing.

On the other hand, if the differential pressure ΔP becomes equal to or lower than the predetermined differential pressure ΔPth (Yes in step S108) or if the differential pressure ΔP is not higher than the predetermined differential pressure ΔPth (No in step S106), the controller C further determines whether the stack temperature T is higher than the predetermined temperature Tth (step S109). If the stack temperature T is higher than the predetermined temperature Tth (Yes in step S109), the controller C adjusts the temperature by adjusting the flow rate(s) of the fuel supply blower 10 and/or the air supply blower 20 such that the stack temperature T is equal to or lower than the predetermined temperature Tth (step S110). Thereafter, the controller C determines whether the stack temperature T becomes equal to or lower than the predetermined temperature Tth (step S111). If the stack temperature T does not become equal to or lower than the predetermined temperature Tth (No in step S111), the controller C shifts the process to step S105, carries out the normal stop, and finishes the processing.

If the stack temperature T becomes equal to or lower than the predetermined temperature Tth (Yes in step S111) or if the stack temperature T is not higher than the predetermined temperature Tth (No in step S109), the controller C shifts the process to step S104.

### First Modification of Operation Control Processing on Gas Concentration G

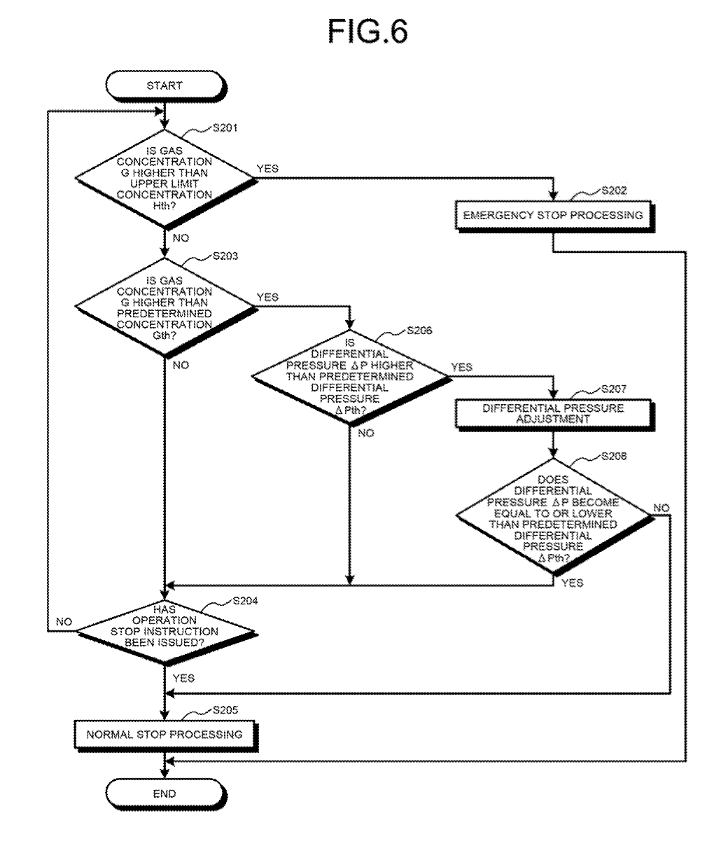

The process in steps S109 to S111 illustrated in FIG. 5 may not be performed. That is to say, the determination processing of determining whether the stack temperature T is higher than the predetermined temperature Tth and the temperature adjustment are not performed, and the normal stop is carried out only when the differential pressure ΔP does not become equal to or lower than the predetermined differential pressure ΔPth even by adjusting the differential pressure in the case where the differential pressure ΔP has been higher than the predetermined differential pressure ΔPth. FIG. 6 is a flowchart illustrating a first modification of the operation control processing procedure on the gas concentration G by the controller C. The first modification of the operation control processing procedure on the gas concentration G by the controller C will be described in detail with reference to the flowchart of FIG. 6.

First, the controller C determines whether the acquired gas concentration G is higher than the upper limit concentration Hth (step S201). If the gas concentration G is higher than the upper limit concentration Hth (Yes in step S201), the controller C controls to perform the emergency-stop on the fuel cell device 1 (step S202) and finishes the processing.

On the other hand, if the gas concentration G is not higher than the upper limit concentration Hth (No in step S201), the controller C further determines whether the gas concentration G is higher than the predetermined concentration Gth (<upper limit concentration Hth) (step S203). If the gas concentration G is not higher than the predetermined concentration Gth (No in step S203), the controller C further determines whether an operation stop instruction has been issued (step S204). If the operation stop instruction has been issued (Yes in step S204), the controller C controls to stop the operation normally (step S205) and finishes the processing. On the other hand, if the operation stop instruction has not been issued (No in step S204), the controller C shifts the process to step S201 and repeats the above-mentioned processing.

If the gas concentration G is higher than the predetermined concentration Gth (Yes in step S203), the controller C further determines whether the differential pressure ΔP is higher than the predetermined differential pressure ΔPth (step S206). If the differential pressure ΔP is higher than the predetermined differential pressure ΔPth (Yes in step S206), the controller C adjusts the differential pressure by adjusting the flow rate(s) of the fuel supply blower 10 and/or the air supply blower 20 and/or adjusts the differential pressure with the differential pressure regulating valve 40 such that the differential pressure ΔP is equal to or lower than the predetermined differential pressure ΔPth (step S207). Thereafter, the controller C determines whether the differential pressure ΔP becomes equal to or lower than the predetermined differential pressure ΔPth (step S208). If the differential pressure ΔP does not become equal to or lower than the predetermined differential pressure ΔPth (No in step S208), the controller C shifts the process to step S205, carries out the normal stop, and finishes the processing.

On the other hand, if the differential pressure ΔP becomes equal to or lower than the predetermined differential pressure ΔPth (Yes in step S208) or if the differential pressure ΔP is not higher than the predetermined differential pressure ΔPth (No in step S206), the controller C shifts the process to step S204.

### Second Modification of Operation Control Processing on Gas Concentration G

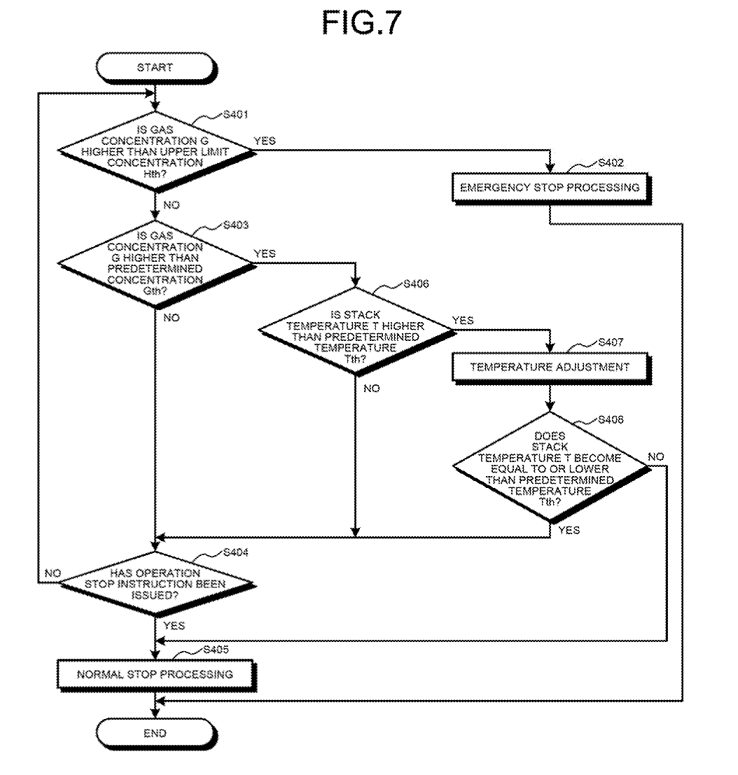

The processing in steps S106 to S108 illustrated in FIG. 5 may not be performed. That is to say, the determination processing of determining whether the differential pressure ΔP is equal to or lower than the predetermined differential pressure ΔPth and the differential pressure adjustment are not performed, and the normal stop is carried out only when the stack temperature T does not become equal to or lower than the predetermined temperature Tth even by adjusting the temperature in the case in which the stack temperature T has been higher than the predetermined temperature Tth. FIG. 7 is a flowchart illustrating a second modification of the operation control processing procedure on the gas concentration G by the controller C. The second modification of the operation control processing procedure on the gas concentration G by the controller C will be described in detail with reference to the flowchart illustrated in FIG. 7.

First, the controller C determines whether the acquired gas concentration G is higher than the upper limit concentration Hth (step S401). If the gas concentration G is higher than the upper limit concentration Hth (Yes in step S401), the controller C controls to perform the emergency-stop on the fuel cell device 1 (step S402) and finishes the processing.

On the other hand, if the gas concentration G is not higher than the upper limit concentration Hth (No in step S401), the controller C further determines whether the gas concentration G is higher than the predetermined concentration Gth (<upper limit concentration Hth) (step S403). If the gas concentration G is not higher than the predetermined concentration Gth (No in step S403), the controller C further determines whether an operation stop instruction has been issued (step S404). If the operation stop instruction has been issued (Yes in step S404), the controller C controls to stop the operation normally (step S405) and finishes the processing. On the other hand, if the operation stop instruction has not been issued (No in step S404), the controller C shifts the process to step S401 and repeats the above-mentioned processing.

If the gas concentration G is higher than the predetermined concentration Gth (Yes in step S403), the controller C further determines whether the stack temperature T is higher than the predetermined temperature Tth (step S406). If the stack temperature T is higher than the predetermined temperature Tth (Yes in step S406), the controller C adjusts the temperature by adjusting the flow rate(s) of the fuel supply blower 10 and/or the air supply blower 20 such that the stack temperature T is equal to or lower than the predetermined temperature Tth (step S407). Thereafter, the controller C determines whether the stack temperature T becomes equal to or lower than the predetermined temperature Tth (step S408). If the stack temperature T does not become equal to or lower than the predetermined temperature Tth (No in step S408), the controller C shifts the process to step S405, carries out the normal stop, and finishes the processing.

If the stack temperature T becomes equal to or lower than the predetermined temperature Tth (Yes in step S408) or if the stack temperature T is not higher than the predetermined temperature Tth (No in step S406), the controller C shifts the process to step S404.

### Third Modification of Operation Control Processing on Gas Concentration G

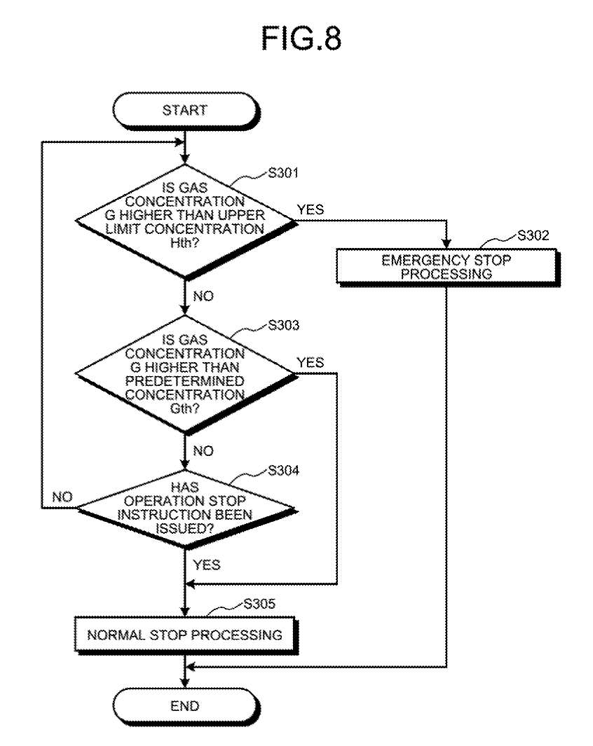

FIG. 8 is a flowchart illustrating a third modification of the operation control processing procedure on the gas concentration G by the controller C. The third modification of the operation control processing procedure on the gas concentration G by the controller C will be described in detail with reference to the flowchart illustrated in FIG. 8.

First, the controller C determines whether the acquired gas concentration G is higher than the upper limit concentration Hth (step S301). If the gas concentration G is higher than the upper limit concentration Hth (Yes in step S301), the controller C controls to perform the emergency-stop on the fuel cell device 1 (step S302) and finishes the processing.

On the other hand, if the gas concentration G is not higher than the upper limit concentration Hth (No in step S301), the controller C further determines whether the gas concentration G is higher than the predetermined concentration Gth (<upper limit concentration Hth) (step S303). If the gas concentration G is not higher than the predetermined concentration Gth (No in step S303), the controller C further determines whether an operation stop instruction has been issued (step S304). If the operation stop instruction has been issued (Yes in step S304), the controller C controls to stop the operation normally (step S305) and finishes the processing. On the other hand, if the operation stop instruction has not been issued (No in step S304), the controller C shifts the process to step S301 and repeats the above-mentioned pieces of processing.

If the gas concentration G is higher than the predetermined concentration Gth (Yes in step S303), the controller C shifts the process to step S305, carries out the normal stop, and finishes the processing.

In the embodiment, in the case in which the gas concentration G is higher than the predetermined concentration Gth (<upper limit concentration Hth), the normal stop is carried out or adjustment for preventing increase in the gas concentration G is performed by adjusting the differential pressure or adjusting the temperature. When the differential pressure in a desired range or the temperature in a desired range is not provided even by the differential pressure adjustment or the temperature adjustment, the normal stop of the operation is carried out early. This early normal stop reduces the number of times of emergency stop to prevent deterioration in catalyst of the fuel cell stack 4, thereby increasing the lifetime of the fuel cell module 2.

According to the present disclosure, even the fuel cell device including the fuel cell module in which the fuel gas possibly cross-leaks to the air electrode side is not emergency-stopped when the gas concentration is equal to or lower than the upper limit concentration, and the processing of preventing increase in the gas concentration is performed when the gas concentration is higher than the predetermined concentration. The number of times of carrying out the emergency stop is therefore reduced, thereby increasing the lifetime of the fuel cell module.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuel cell device comprising:
a solid oxide fuel cell including
a fuel electrode to which a fuel is supplied,
an air electrode to which air is supplied, and
an electrolyte provided between the fuel electrode and the air electrode;
an air-tight housing in which the solid oxide fuel cell is arranged;
a gas concentration detector configured to detect a gas concentration of a combustible stagnant gas stagnating in an upper portion of the air-tight housing;
a differential pressure detector configured to detect a differential pressure between the fuel in the fuel electrode and the air in the air electrode; and
a controller configured to
perform an emergency stop on the fuel cell device to stop the fuel cell device by instantly stopping the supply of the fuel to the fuel electrode when the gas concentration is higher than an upper limit concentration,
perform an adjustment on the differential pressure such that the differential pressure is equal to or lower than a predetermined differential pressure when the gas concentration is not higher than the upper limit concentration, the gas concentration is higher than a predetermined concentration, and the differential pressure is higher than the predetermined differential pressure, and
perform a normal stop on the fuel cell device to stop the fuel cell device by lowering a temperature of the fuel cell device while supplying the fuel to the fuel electrode when the differential pressure does not become equal to or lower than the predetermined differential pressure even by adjusting the differential pressure
wherein the adjustment of the differential pressure is performed by adjusting at least one of a flow rate of the fuel, a flow rate of the air, and an opening of a differential pressure regulating valve.

2. A fuel cell device comprising:
a solid oxide fuel cell including
a fuel electrode to which a fuel is supplied,
an air electrode to which air is supplied, and
an electrolyte provided between the fuel electrode and the air electrode;
an air-tight housing in which the solid oxide fuel cell is arranged;
a gas concentration detector configured to detect a gas concentration of a combustible stagnant gas stagnating in an upper portion of the air-tight housing;
a temperature detector configured to detect a temperature of the solid oxide fuel cell;
a differential pressure detector configured to detect a differential pressure between the fuel in the fuel electrode and the air in the air electrode; and
a controller configured to
perform an emergency stop on the fuel cell device to stop the fuel cell device by instantly stopping the supply of the fuel to the fuel electrode when the gas concentration is higher than an upper limit concentration,
perform an adjustment on the differential pressure such that the differential pressure is equal to or lower than a predetermined differential pressure when the gas concentration is not higher than the upper limit concentration, the gas concentration is higher than a predetermined concentration, and the differential pressure is higher than the predetermined differential pressure,
perform an adjustment on the temperature such that the temperature is equal to or lower than a predetermined temperature when the gas concentration is higher than the predetermined concentration, the differential pressure is equal to or lower than the predetermined differential pressure, and the temperature is higher than the predetermined temperature, and
perform a normal stop on the fuel cell device to stop the fuel cell device by lowering a temperature of the fuel cell device while supplying the fuel to the fuel electrode when the temperature does not become equal to or lower than the predetermined temperature even by adjusting the temperature,
wherein the adjustment of the differential pressure is performed by adjusting at least one of a flow rate of the fuel, a flow rate of the air, and an opening of a differential pressure regulating valve, and
wherein the adjustment of the temperature is performed by adjusting at least one of the flow rate of the fuel and the flow rate of the air.

3. A fuel cell device comprising:
a solid oxide fuel cell including
a fuel electrode to which fuel is supplied,
an air electrode to which air is supplied, and
an electrolyte provided between the fuel electrode and the air electrode;
an air-tight housing in which the solid oxide fuel cell is arranged;
a gas concentration detector configured to detect a gas concentration of a combustible stagnant gas stagnating in an upper portion of the air-tight housing;
a temperature detector configured to detect a temperature of the solid oxide fuel cell; and
a controller configured to
perform an emergency stop on the fuel cell device to stop the fuel cell device by instantly stopping the supply of the fuel to the fuel electrode when the gas concentration is higher than an upper limit concentration,
perform an adjustment on the temperature such that the temperature is equal to or lower than a predetermined temperature when the gas concentration is not higher than the upper limit concentration, the gas concentration is higher than a predetermined concentration, and the temperature is higher than the predetermined temperature, and
perform a normal stop on the fuel cell device to stop the fuel cell device by lowering a temperature of the fuel cell device while supplying the fuel to the fuel electrode when the temperature does not become equal to or lower than the predetermined temperature even by adjusting the temperature,
wherein the adjustment of the temperature is performed by adjusting at least one of a flow rate of the fuel and a flow rate of the air.

4. The fuel cell device according to claim 1, further comprising a pipe communicating the upper portion in the air-tight housing and outside of the air-tight housing, wherein
the gas concentration detector is provided on the pipe.

5. The fuel cell device according to claim 4, further comprising a cooling unit at an upstream side relative to the gas concentration detector on the pipe.

6. An operation control method for a fuel cell device that includes a solid oxide fuel cell including a fuel electrode to which a fuel is supplied, an air electrode to which air is supplied, and an electrolyte provided between the fuel electrode and the air electrode, the solid oxide fuel cell being arranged in an air-tight housing, the operation control method comprising:
detecting a gas concentration of a combustible stagnant gas stagnating in an upper portion of the air-tight housing and performing an emergency stop on the fuel cell device to stop the fuel cell device by instantly stopping the supply of the fuel to the fuel electrode when the gas concentration is higher than an upper limit concentration;
detecting a differential pressure between the fuel in the fuel electrode and the air in the air electrode when the gas concentration is not higher than the upper limit concentration and the gas concentration is higher than a predetermined concentration, and performing an adjustment on the differential pressure such that the differential pressure is equal to or lower than a predetermined differential pressure when the differential pressure is higher than the predetermined differential pressure; and
performing a normal stop on the fuel cell device to stop the fuel cell device by lowering a temperature of the fuel cell device while supplying the fuel to the fuel electrode when the differential pressure does not become equal to or lower than the predetermined differential pressure even by adjusting the differential pressure,
wherein the adjustment of the differential pressure is performed by adjusting at least one of a flow rate of the fuel, a flow rate of the air, and an opening of a differential pressure regulating valve.

7. An operation control method for a fuel cell device that includes a solid oxide fuel cell including a fuel electrode to which fuel is supplied, an air electrode to which air is supplied, and an electrolyte provided between the fuel electrode and the air electrode, the solid oxide fuel cell being arranged in an air-tight housing, the operation control method comprising:
detecting a gas concentration of a combustible stagnant gas stagnating in an upper portion of the air-tight housing and performing an emergency stop on the fuel cell device to stop the fuel cell device by instantly stopping the supply of the fuel to the fuel electrode when the gas concentration is higher than an upper limit concentration;
detecting a differential pressure between the fuel in the fuel electrode and the air in the air electrode when the gas concentration is not higher than the upper limit concentration and the gas concentration is higher than a predetermined concentration, and performing an adjustment on the differential pressure such that the differential pressure is equal to or lower than a predetermined differential pressure when the differential pressure is higher than the predetermined differential pressure;
detecting a temperature of the solid oxide fuel cell when the gas concentration is higher than the predetermined concentration and the differential pressure is equal to or lower than the predetermined differential pressure, and performing an adjustment on the temperature such that the temperature is equal to or lower than a predetermined temperature when the temperature is higher than the predetermined temperature; and
performing a normal stop on the fuel cell device to stop the fuel cell device by lowering a temperature of the fuel cell device while supplying the fuel to the fuel electrode when the temperature does not become equal to or lower than the predetermined temperature even by adjusting the temperature,
wherein the adjustment of the differential pressure is performed by adjusting at least one of a flow rate of the fuel, a flow rate of the air, and an opening of a differential pressure regulating valve, and
wherein the adjustment of the temperature is performed by adjusting at least one of the flow rate of the fuel and the flow rate of the air.

8. An operation control method for a fuel cell device that includes a solid oxide fuel cell including a fuel electrode to which fuel is supplied, an air electrode to which air is supplied, and an electrolyte provided between the fuel electrode and the air electrode, the solid oxide fuel cell being arranged in an air-tight housing, the operation control method comprising:
detecting a gas concentration of combustible stagnant gas stagnating in an upper portion of the air-tight housing and performing an emergency stop on the fuel cell device to stop the fuel cell device by instantly stopping the supply of the fuel to the fuel electrode when the gas concentration is higher than an upper limit concentration;
detecting a temperature of the solid oxide fuel cell when the gas concentration is not higher than the upper limit concentration and the gas concentration is higher than a predetermined concentration, and performing an adjustment on the temperature such that the temperature is equal to or lower than a predetermined temperature when the temperature is higher than the predetermined temperature; and
performing a normal stop on the fuel cell device to stop the fuel cell device by lowering a temperature of the fuel cell device while supplying the fuel to the fuel electrode when the temperature does not become equal to or lower than the predetermined temperature even by adjusting the temperature,
wherein the adjustment of the temperature is performed by adjusting at least one of a flow rate of the fuel and a flow rate of the air.
